(19) United States
(12) Patent Application Publication
(10) Pub. No.: US 2025/0330084 A1
(43) Pub. Date: Oct. 23, 2025

(54) Buck-boost converter and related feedback circuit with extended ramp control

(71) Applicant: NOVATEK Microelectronics Corp., Hsin-Chu (TW)

(72) Inventors: Chieh-Ju Tsai, Kinmen County (TW); Yu-Ting Hung, Taipei City (TW); Ching-Jan Chen, Taipei City (TW); Chan-Hsuan Hsu, Taipei City (TW); Chun-Yu Hsieh, Miaoli County (TW)

(73) Assignee: NOVATEK Microelectronics Corp., Hsin-Chu (TW)

(21) Appl. No.: 18/966,146

(22) Filed: Dec. 3, 2024

Related U.S. Application Data
(60) Provisional application No. 63/635,628, filed on Apr. 18, 2024.

(51) Int. Cl. H02M 3/157; H02M 1/00; H02M 1/14; H02M 3/07; H02M 3/158

(52) U.S. Cl. CPC H02M 3/157; H02M 1/0025; H02M 1/14; H02M 3/07; H02M 3/1582

(57) ABSTRACT

A feedback circuit for a buck-boost converter having an input voltage and an output voltage includes an error amplifier, a ramp generator, a first comparator and a digital control circuit. The error amplifier is configured to generate an error voltage according to the output voltage. The ramp generator is configured to generate a ramp voltage. The first comparator, coupled to the error amplifier and the ramp generator, is configured to compare the error voltage with the ramp voltage to generate a control signal. The digital control circuit, coupled to the first comparator, is configured to generate a plurality of switching signals according to the control signal and a reference duty signal.

### CROSS REFERENCE TO RELATED APPLICATIONS

This application claims the benefit of U.S. Provisional Application No. 63/635,628, filed on Apr. 18, 2024. The content of the application is incorporated herein by reference.

### BACKGROUND OF THE INVENTION

### 1. FIELD OF THE INVENTION

The present invention relates to a buck-boost converter, and more particularly, to a buck-boost converter with extended ramp control.

### 2. DESCRIPTION OF THE PRIOR ART

Power converters are widely used in various electronic systems, to provide a stable voltage supply. The power converters may generally include two types: the switching-capacitor type and switching-inductor type, to meet different requirements such as different load magnitudes.

Among those power converters, a buck-boost converter features the capability of generating an output voltage which may be larger than or smaller than its input voltage. In general, the buck-boost converter provides a buck mode and a boost mode for different voltage transitions. If the input voltage is close to the output voltage, the nonlinearity of pulse width modulation (PWM) control will cause that the switching operations of the power converter may not provide an accurate duty control, resulting in larger output ripples. In order to solve this problem, a buck-boost mode is included to cover the scenario where the input voltage and the output voltage are close to each other.

However, the buck-boost mode requires more switching operations in the switches of the power stage, which is accompanied by a larger switching loss. There may also be a larger conduction loss due to the larger average inductor current in the buck-boost mode, resulting in a worse efficiency.

### SUMMARY OF THE INVENTION

It is therefore an objective of the present invention to provide a novel feedback control circuit using extended ramp control for a buck-boost converter, in order to solve the abovementioned problems.

An embodiment of the present invention discloses a feedback circuit for a buck-boost converter. The buck-boost converter has an input voltage and an output voltage. The feedback circuit comprises an error amplifier, a ramp generator, a first comparator and a digital control circuit. The error amplifier is configured to generate an error voltage according to the output voltage. The ramp generator is configured to generate a ramp voltage. The first comparator, coupled to the error amplifier and the ramp generator, is configured to compare the error voltage with the ramp voltage to generate a control signal. The digital control circuit, coupled to the first comparator, is configured to generate a plurality of switching signals according to the control signal and a reference duty signal.

Another embodiment of the present invention discloses a buck-boost converter, which comprises a power stage and a feedback circuit. The power stage is configured to receive an input voltage to generate an output voltage. The feedback circuit, coupled to the power stage, comprises an error amplifier, a ramp generator, a first comparator and a digital control circuit. The error amplifier is configured to generate an error voltage according to the output voltage. The ramp generator is configured to generate a ramp voltage. The first comparator, coupled to the error amplifier and the ramp generator, is configured to compare the error voltage with the ramp voltage to generate a control signal. The digital control circuit, coupled to the first comparator, is configured to generate a plurality of switching signals according to the control signal and a reference duty signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a 4-switch buck-boost converter.

FIG. 2A illustrates an exemplary operation of the buck-boost converter in the buck mode.

FIG. 2B illustrates an exemplary operation of the buck-boost converter in the boost mode.

FIG. 2C illustrates an exemplary operation of the buck-boost converter in the buck-boost mode.

FIG. 3 is a schematic diagram of a buck-boost converter according to an embodiment of the present invention.

FIG. 4 illustrates the operating principle of the extended ramp control according to an embodiment of the present invention.

FIG. 5 is a schematic diagram of a hybrid buck-boost converter according to an embodiment of the present invention.

FIG. 6A illustrates an exemplary operation of the hybrid buck-boost converter in the buck mode.

FIG. 6B illustrates an exemplary operation of the hybrid buck-boost converter in the boost mode.

FIG. 7 illustrates a detailed implementation of the buck-boost converter shown in FIG. 3.

FIG. 8A and FIG. 8B are waveform diagrams of an operation of the feedback circuit controlling the hybrid buck-boost converter.

FIG. 9 is a schematic diagram of an exemplary implementation of the digital control circuit according to an embodiment of the present invention.

### DETAILED DESCRIPTION

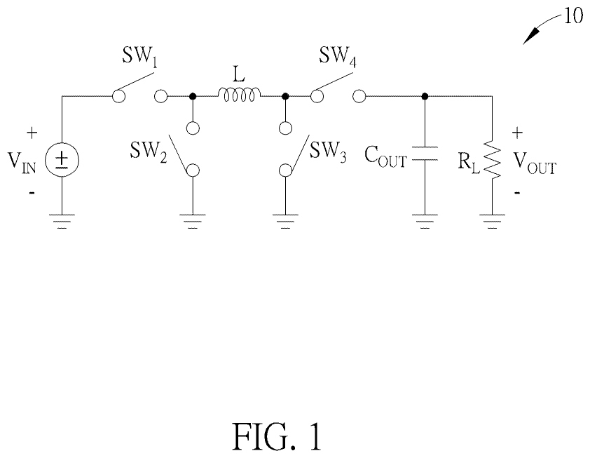

FIG. 1 is a schematic diagram of a 4-switch buck-boost converter 10. The buck-boost converter 10, which is configured to receive an input voltage V_{IN} to generate an output voltage V_{OUT}, includes an inductor L and 4 switches SW₁-SW₄. An output capacitor C_{OUT} and a resistive load R_{L}, which may not be included in the buck-boost converter 10, are also illustrated in FIG. 1 to facilitate the illustrations. The buck-boost converter 10 is a switching-inductor type power converter, in which an inductor current flowing through the inductor L is controlled by appropriately switching the switches SW₁-SW₄, to supply power to the output terminal and generate a stable output voltage V_{OUT}.

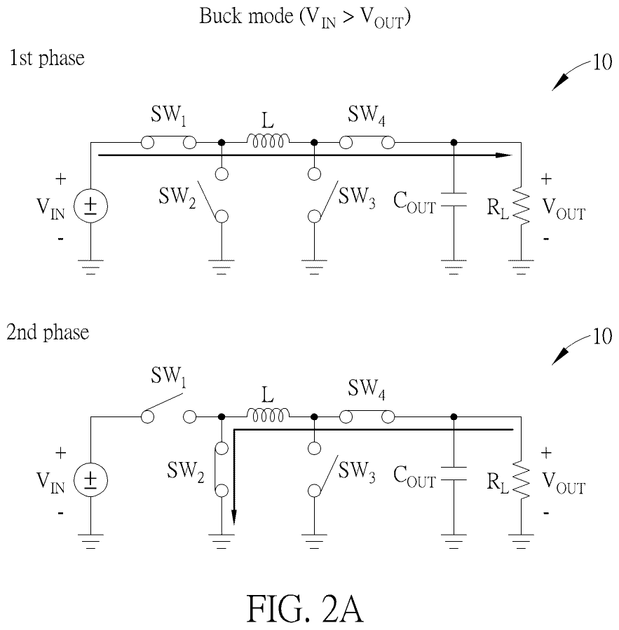

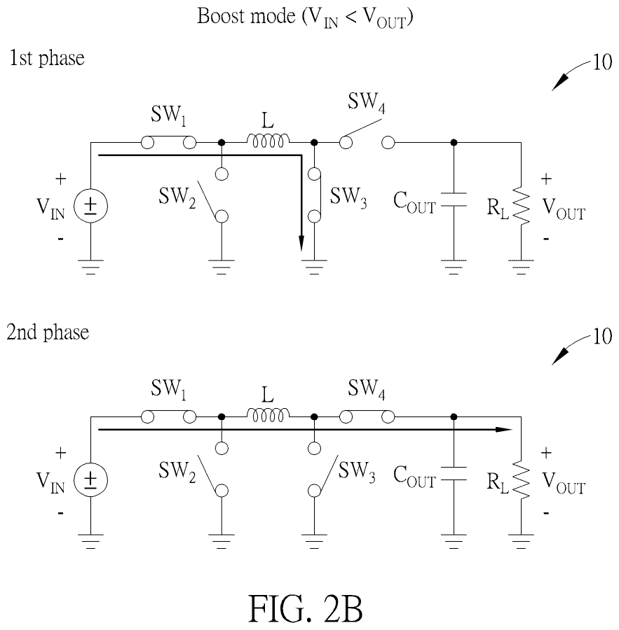

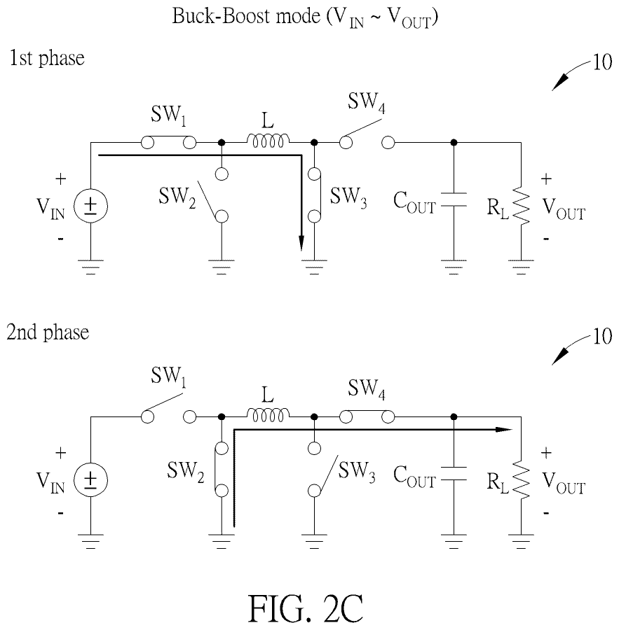

The buck-boost converter 10 may be operated in a buck mode or a boost mode. If the input voltage V_{IN} is larger than the output voltage V_{OUT}, the buck-boost converter 10 will be operated in the buck mode. FIG. 2A illustrates an exemplary operation of the buck-boost converter 10 in the buck mode. As shown in FIG. 2A, there are two phases in the buck mode. In the first phase, the switches SW₁ and SW₄ are on and the switches SW₂ and SW₃ are off. In the second phase, the switches SW₂ and SW₄ are on and the switches SW₁ and SW₃ are off.

If the input voltage V_{IN} is smaller than the output voltage V_{OUT}, the buck-boost converter 10 will be operated in the boost mode. FIG. 2B illustrates an exemplary operation of the buck-boost converter 10 in the boost mode. As shown in FIG. 2B, there are two phases in the boost mode. In the first phase, the switches SW₁ and SW₃ are on and the switches SW₂ and SW₄ are off. In the second phase, the switches SW₁ and SW₄ are on and the switches SW₂ and SW₃ are off.

As mentioned above, in order to solve the nonlinearity problem when the input voltage V_{IN} is close to the output voltage V_{OUT}, the buck-boost converter 10 may be operated in a buck-boost mode, as shown in FIG. 2C. The buck-boost mode also has two phases. In the first phase, the switches SW₁ and SW₃ are on and the switches SW₂ and SW₄ are off. In the second phase, the switches SW₂ and SW₄ are on and the switches SW₁ and SW₃ are off.

As can be seen in FIGS. 2A-2C, in the buck-boost mode, all of the 4 switches SW₁-SW₄ change states during the switching between two phases; hence, the switching loss in the buck-boost mode is greater than that in the buck mode or boost mode. The switching method would also cause that the average inductor current is twice the load current in the buck-boost mode, which is greater than the case in the buck mode or boost mode under similar duty control. This results in a larger conduction loss in the buck-boost mode. As a result, the efficiency of the buck-boost converter 10 may be decreased when the buck-boost mode is applied.

Therefore, the industry has developed several schemes to solve the problem of inaccuracy duty control when the input voltage is close to the output voltage without the usage of the buck-boost mode. For example, the buck-boost converter may use a dual-ramp control, where a ramp voltage is operated in the buck mode and another ramp voltage is operated in the boost mode when the output voltage is close to the input voltage. The outputs of the two ramp controls are applied alternately to generate the output voltage. However, the dual-ramp control scheme requires two ramp generators in the control circuit, which is accompanied by a larger quiescent current. The offset between the two ramp generators may also reduce the accuracy of ramp control. Also note that there may be a larger output fluctuation when the input voltage is close to the output voltage and/or when mode transition is performed.

The present invention provides an extended ramp control scheme for a buck-boost converter. The extended ramp control scheme uses only one ramp voltage to realize the feedback control of the buck-boost converter; hence, there may be only one ramp generator, and thus the quiescent current of the ramp generator may be reduced. A reference duty signal is applied to separate the buck mode and the boost mode, where no buck-boost mode is applied, so that the control circuit is immune to the lower efficiency of the buck-boost mode.

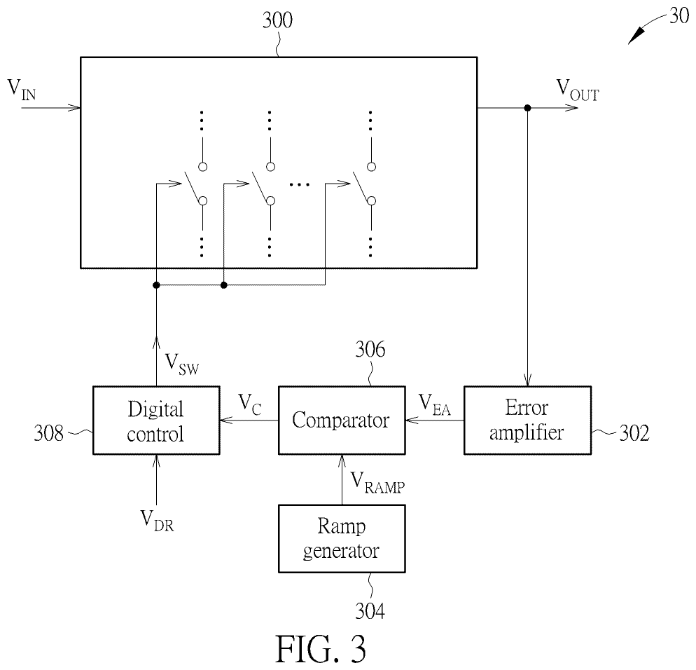

FIG. 3 is a schematic diagram of a buck-boost converter 30 according to an embodiment of the present invention. The buck-boost converter 30 includes a power stage 300 which is controlled by a feedback circuit. The feedback circuit includes an error amplifier 302, a ramp generator 304, a comparator 306 and a digital control circuit 308. The power stage 300 is configured to receive an input voltage V_{IN} to generate an output voltage V_{OUT}, and output the output voltage V_{OUT} with sufficient energies to the load. In various embodiments, the power stage 300 may be composed of one or more power elements and several switches, such as the buck-boost converter 10 shown in FIG. 1, but not limited thereto.

In the feedback circuit, the error amplifier 302 is configured to generate an error voltage V_{EA} according to the output voltage V_{OUT}. The ramp generator 304 is configured to generate a ramp voltage V_{RAMP} and provide the ramp voltage V_{RAMP} to the comparator 306. The comparator 306 may compare the error voltage V_{EA} with the ramp voltage V_{RAMP} to generate a control signal V_{C}. The digital control circuit 308 may receive the control signal V_{C} output by the comparator 306 and also receive a reference duty signal V_{DR}. Therefore, the digital control circuit 308 may generate one or more switching signals V_{SW} according to the control signal V_{C} and the reference duty signal V_{DR}.

The reference duty signal V_{DR} provided for the digital control circuit 308 may be used to determine the operation mode of the buck-boost converter 30. Based on the operation mode, the digital control circuit 308 may output the switching signals V_{SW} to control the switches of the power stage 300 in an appropriate manner.

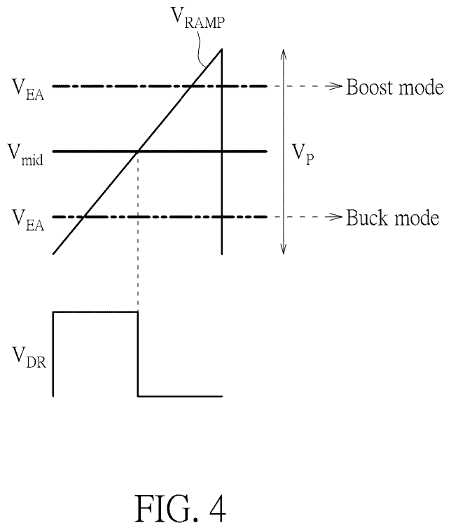

FIG. 4 illustrates the operating principle of the extended ramp control according to an embodiment of the present invention, where the waveforms of a reference voltage V_{mid}, the error voltage V_{EA}, the ramp voltage V_{RAMP}, and the reference duty signal V_{DR} are shown. The reference duty signal V_{DR} is a pulse signal, in which the pulse edge corresponds to the intersection of the ramp voltage V_{RAMP} and the reference voltage V_{mid}. Based on the reference duty signal V_{DR}, the digital control circuit 308 may determine the operation mode of the buck-boost converter 30; that is, to determine that the buck-boost converter 30 is operated in the buck mode or the boost mode. More specifically, when the error voltage V_{EA} is smaller than the reference voltage V_{mid}, the buck-boost converter 30 may be operated in the buck mode; and when the error voltage V_{EA} is larger than the reference voltage V_{mid}, the buck-boost converter 30 may be operated in the boost mode. Therefore, with the extended ramp control scheme, the same ramp voltage V_{RAMP} is used to control the operation mode of the buck-boost converter and also used to generate the control signal V_{C} for phase switching control. No other ramp voltage or ramp generator is included.

In a preferable embodiment, the reference voltage V_{mid} is on the middle level of the ramp voltage V_{RAMP}. In other words, the reference voltage V_{mid} is equal to one half of the peak amplitude V_{P} of the ramp voltage V_{RAMP}. Correspondingly, the duty cycle of the reference duty signal V_{DR} is substantially equal to 50%.

Note that the extended ramp control scheme of the present invention is applicable to various buck-boost converters. In an embodiment, the extended ramp control scheme is applied to a hybrid buck-boost converter, in which a flying capacitor is further deployed in addition to the inductor. With the flying capacitor, the same output power may be achieved by using a smaller inductor, thereby improving the power density and reducing the circuit cost. In addition, the hybrid buck-boost converter may provide continuous energy delivery, which leads to smaller ripples on the output voltage V_{OUT}.

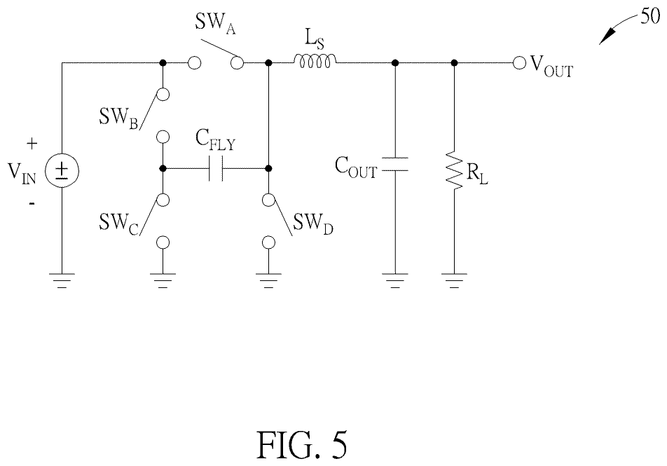

FIG. 5 is a schematic diagram of a hybrid buck-boost converter 50 according to an embodiment of the present invention. The structure of the hybrid buck-boost converter 50 shown in FIG. 5 is also known as the KY buck-boost converter. The hybrid buck-boost converter 50 includes 4 switches SW_{A}-SW_{D}, an inductor L_{S} and a flying capacitor C_{FLY}. An output capacitor C_{OUT} and a resistive load R_{L} are also shown in FIG. 5, as similar to those shown in FIG. 1. In the hybrid buck-boost converter 50, the inductor L_{S} is connected to the output terminal, and the flying capacitor C_{FLY} is coupled between the 4 switches SW_{A}-SW_{D}.

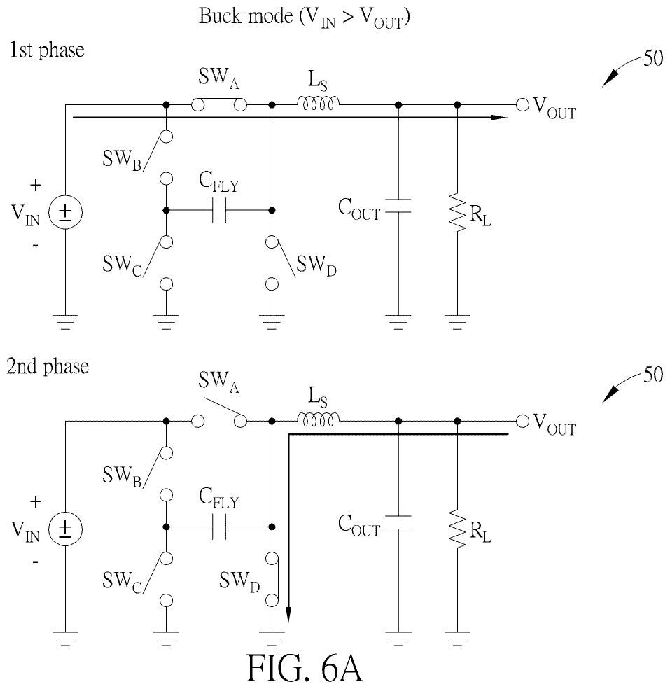

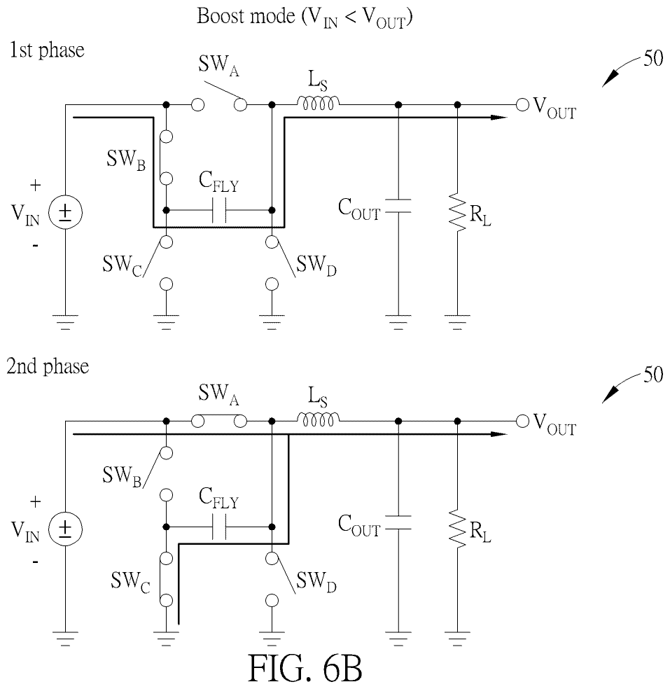

Similarly, the hybrid buck-boost converter 50 may be operated in a buck mode or a boost mode. If the input voltage V_{IN} is larger than the output voltage V_{OUT}, the hybrid buck-boost converter 50 will be operated in the buck mode. FIG. 6A illustrates an exemplary operation of the hybrid buck-boost converter 50 in the buck mode. As shown in FIG. 6A, there are two phases in the buck mode. In the first phase, the switch SW_{A} is on and the switches SW_{B}, SW_{C} and SW_{D} are off. In the second phase, the switch SW_{D} is on and the switches SW_{A}, SW_{B} and SW_{C} are off.

If the input voltage V_{IN} is smaller than the output voltage V_{OUT}, the hybrid buck-boost converter 50 will be operated in the boost mode. FIG. 6B illustrates an exemplary operation of the hybrid buck-boost converter 50 in the boost mode. As shown in FIG. 6B, there are two phases in the boost mode. In the first phase, the switch SW_{B} is on and the switches SW_{A}, SW_{C} and SW_{D} are off. In the second phase, the switches SW_{A} and SW_{C} are on and the switches SW_{B} and SW_{D} are off.

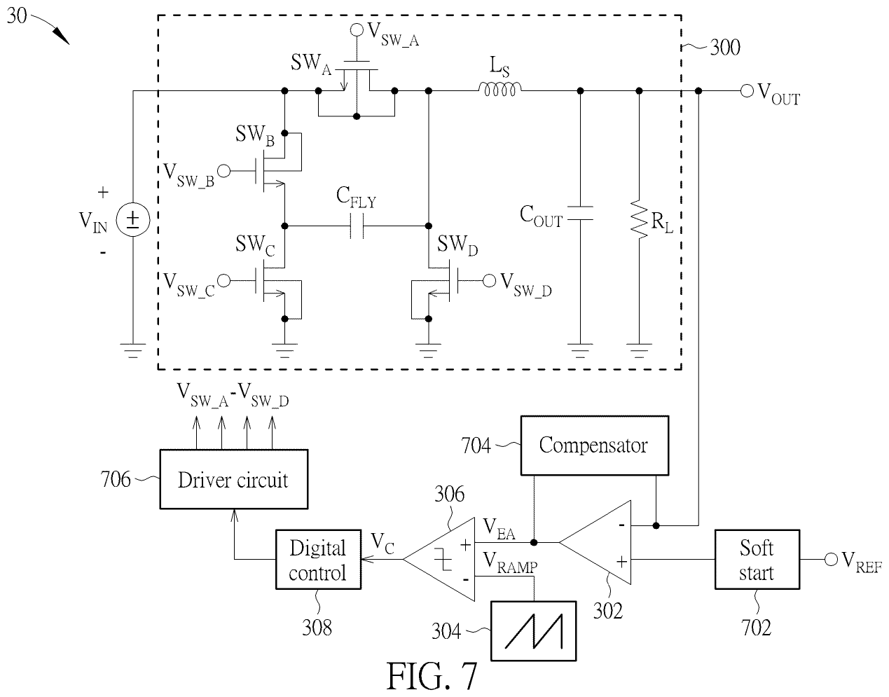

FIG. 7 illustrates a detailed implementation of the buck-boost converter 30, of which the power stage 300 may be implemented to have the structure of the hybrid buck-boost converter 50 shown in FIG. 5. In the power stage 300, each of the switches SW_{A}-SW_{D} may be implemented by using a transistor.

As shown in FIG. 7, the feedback circuit for controlling the power converter 300 is a detailed implementation of the feedback circuit shown in FIG. 3. In detail, in addition to receiving the output voltage V_{OUT}, the error amplifier 302 may also receive a reference voltage V_{REF}, which may be provided through a soft start circuit 702, to generate the error voltage V_{EA}. Through well design of the reference voltage V_{REF}, the output voltage V_{OUT} may be controlled to keep at a desired level. Preferably, a compensator 704 may be deployed and coupled to the error amplifier 302, to improve the stability of the feedback loop.

In this embodiment, since the power stage 300 has 4 switches SW_{A}-SW_{D}, the digital control circuit 308 may generate 4 switching signals V_{SW_A}-V_{SW_D} for controlling the switches SW_{A}-SW_{D}. In an embodiment, a driving circuit 706 may be deployed and coupled between the digital control circuit 308 and the power stage 300, to forward the switching signals V_{SW_A}-V_{SW_D} to the switches SW_{A}-SW_{D}, respectively. The driving circuit 706 may provide sufficient driving capability to drive the switches SW_{A}-SW_{D}. Preferably, the driving circuit 706 may also provide a dead-time control function, to finely tune the turn-on and/or turn-off timing of the switches SW_{A}-SW_{D} to prevent the shoot-through problem.

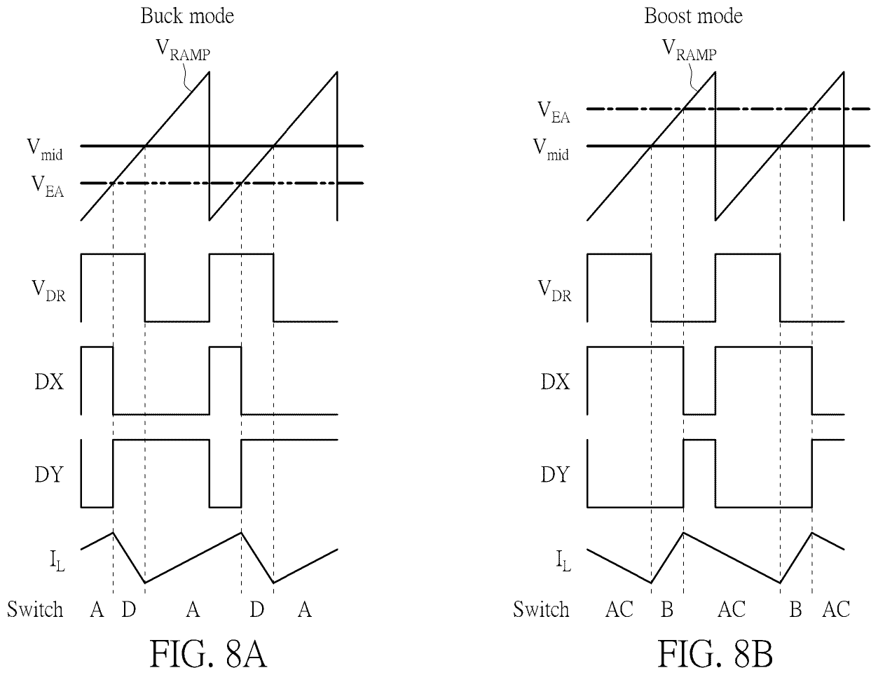

FIGS. 8A and 8B are waveform diagrams of an operation of the feedback circuit controlling the hybrid buck-boost converter 50, where the waveforms of the reference voltage V_{mid}, the error voltage V_{EA}, the ramp voltage V_{RAMP}, the reference duty signal V_{DR}, duty control signals DX and DY, and an inductor current I_{L} are shown. The states of the switches SW_{A}-SW_{D} are also shown in FIGS. 8A and 8B, where the specified switch symbol refers to the turn-on switch(s) in each phase. Since the ramp voltage V_{RAMP} is output periodically, the reference duty signal V_{DR} may be a periodic pulse signal. The duty control signals DX and DY may serve as the control signal V_{C} output by the comparator 306 based on the comparison result of the error voltage V_{EA} and the ramp voltage V_{RAMP}. In this embodiment, the duty control signal DX is “high” when the error voltage V_{EA} is larger than the ramp voltage V_{RAMP}, and is “low” when the error voltage V_{EA} is smaller than the ramp voltage V_{RAMP}. The duty control signal DY, which is an inverse of the duty control signal DX, is “high” when the error voltage V_{EA} is smaller than the ramp voltage V_{RAMP}, and is “low” when the error voltage V_{EA} is larger than the ramp voltage V_{RAMP}.

FIG. 8A illustrates the operation in the buck mode, where the error voltage V_{EA} is smaller than the reference voltage V_{mid}. FIG. 8B illustrates the operation in the boost mode, where the error voltage V_{EA} is larger than the reference voltage V_{mid}. The switching operations in the buck mode and the boost mode may be controlled by using the reference duty signal V_{DR}. In this embodiment, the switching control of the buck mode is operated in the period where the ramp voltage V_{RAMP} is smaller than the reference voltage V_{mid}, where the reference duty signal V_{DR} is “high”; and the switching control of the boost mode is operated in the period where the ramp voltage V_{RAMP} is larger than the reference voltage V_{mid}, where the reference duty signal V_{DR} is “low”.

Refer to the waveforms of FIG. 8A along with the switching operation of the buck mode shown in FIG. 6A and the structure of the hybrid buck-boost converter 50 and its control circuit shown in FIG. 7. As mentioned above, in the buck mode, the switching control is operated in the period where the ramp voltage V_{RAMP} is smaller than the reference voltage V_{mid}, i.e., the lower-half cycle of the ramp voltage V_{RAMP}. With the control of the duty control signals DX and DY, the digital control circuit 308 may generate the switching signals V_{SW_A}-V_{SW_D} appropriately, to turn on the switch SW_{A} and turn off other switches in the first phase and turn on the switch SW_{D} and turn off other switches in the second phase, as the operations shown in FIG. 6A.

Refer to the waveforms of FIG. 8B along with the switching operation of the boost mode shown in FIG. 6B and the structure of the hybrid buck-boost converter 50 and its control circuit shown in FIG. 7. As mentioned above, in the boost mode, the switching control is operated in the period where the ramp voltage V_{RAMP} is larger than the reference voltage V_{mid}, i.e., the higher-half cycle of the ramp voltage V_{RAMP}. With the control of the duty control signals DX and DY, the digital control circuit 308 may generate the switching signals V_{SW_A}-V_{SW_D} appropriately, to turn on the switch SW_{B} and turn off other switches in the first phase and turn on the switches SW_{A} and SW_{C} and turn off other switches in the second phase, as the operations shown in FIG. 6B.

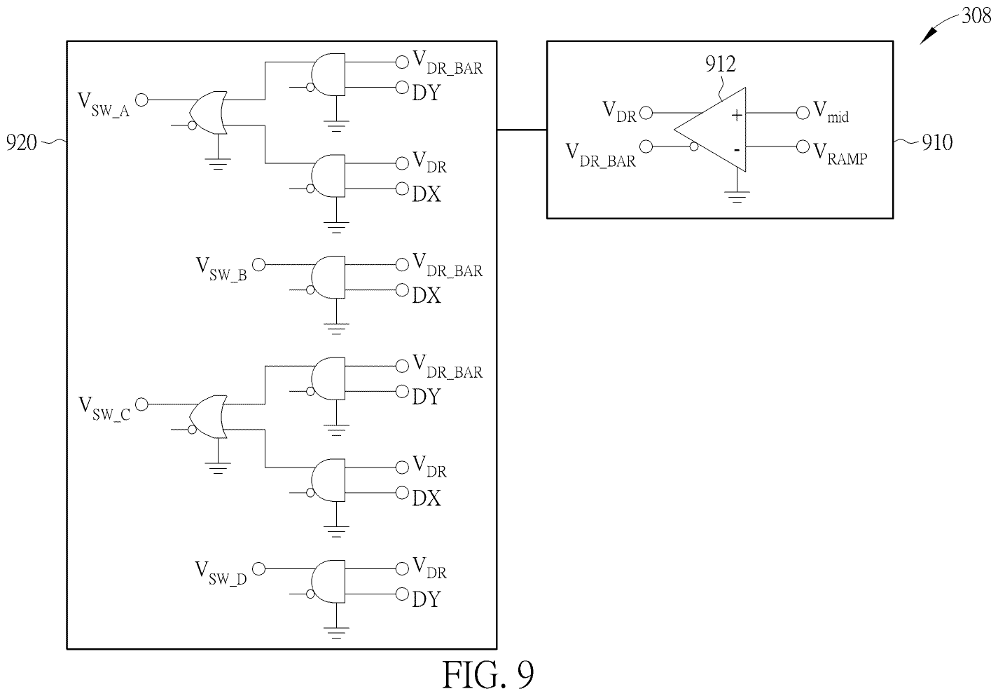

FIG. 9 is a schematic diagram of an exemplary implementation of the digital control circuit 308 according to an embodiment of the present invention. The digital control circuit 308 includes a reference duty generator 910 and a logic circuit 920. In detail, the reference duty generator 910 may include a comparator 912, which may be coupled to the ramp generator 304 to receive the ramp voltage V_{RAMP}. The comparator 912 is configured to compare the ramp voltage V_{RAMP} with the reference voltage V_{mid} to generate the reference duty signal V_{DR}and inverse reference duty signal V_{DR_BAR}.

The logic circuit 920 is configured to perform logic operations on the control signal V_{C} (which may include the duty control signals DX and/or DY) and the reference duty signal V_{DR} (and/or the inverse reference duty signal V_{DR_BAR}), to generate each of the switching signals V_{SW_A}-V_{SW_D}. In various embodiments, the logic circuit 920 may be implemented by using a combination of multiple logic gates, including “AND” gate(s), “OR” gate(s), and/or inverter(s), in order to generate the desired switching signals V_{SW_A}-V_{SW-D}. An exemplary implementation of the logic circuit 920 is shown in FIG. 9. The related implementation should be well known by a person of ordinary skill in the art, and will not be detailed herein.

Note that the structure of the logic circuit 920 shown in FIG. 9 is one of various implementations of the present invention. In fact, the desired switching signals V_{SW-A}-V_{SW-D} may be generated by using any possible combinations of various logic gates, not limited to those shown in FIG. 9. In another embodiment, if the digital control circuit 308 is used for another type of buck-boost converter, such as the general 4-switch buck-boost converter shown in FIG. 1, the logic circuit may be implemented in another manner to generate different switching signals.

In various embodiments of the present invention, the feedback control circuit of the buck-boost converter may perform error voltage comparison by using only one ramp generator and ramp voltage. For example, in the buck-boost converter 30, the error voltage V_{EA} is only compared with the ramp voltage V_{RAMP} without being compared with any other ramp voltage, and the control signal V_{C} is generated accordingly. The only one ramp generator allows the quiescent current consumed by the ramp generator to be minimized. In comparison with the conventional voltage mode control that applies two ramp voltages to be compared with the error voltage, the extended ramp control scheme of the present invention may also achieve the benefits of smaller inductor current ripples. In addition, in the present invention, since the switching between the buck mode and the boost mode is in the middle of the ramp voltage V_{RAMP}, the output voltage V_{OUT} generated during mode transition may not suffer from the nonlinearity problem; hence, the output voltage V_{OUT} will be smoother, which means that the fluctuation of the output voltage V_{OUT} may be reduced.

To sum up, the present invention provides a novel feedback control circuit for a buck-boost converter, where an extended ramp control scheme is applied. In the feedback circuit, only one ramp voltage is used to be compared with the error voltage, to perform duty control on the switching signals. There is no buck-boost mode, and no other ramp voltage used for the duty control. A reference voltage, which may be equal to one half of the peak amplitude of the ramp voltage, is applied to generate a reference duty signal, which is further used to determine that the buck-boost converter should be operated in the buck mode or the boost mode, so as to realize the extended ramp control by using only one ramp voltage. The extended ramp control scheme of the present invention may improve the performance of the buck-boost converter in various aspects, such as a more stable and smoother output voltage with smaller ripples and less current consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A feedback circuit for a buck-boost converter, the buck-boost converter having an input voltage and an output voltage, the feedback circuit comprising:
an error amplifier, configured to generate an error voltage according to the output voltage;
a ramp generator, configured to generate a ramp voltage;
a first comparator, coupled to the error amplifier and the ramp generator, configured to compare the error voltage with the ramp voltage to generate a control signal; and
a digital control circuit, coupled to the first comparator, configured to generate a plurality of switching signals according to the control signal and a reference duty signal.

2. The feedback circuit of claim 1, wherein the error voltage is only compared with the ramp voltage without being compared with another ramp voltage.

3. The feedback circuit of claim 1, wherein the digital control circuit comprises:
a second comparator, coupled to the ramp generator, configured to compare the ramp voltage with a reference voltage to generate the reference duty signal.

4. The feedback circuit of claim 3, wherein the reference voltage is substantially equal to one half of a peak amplitude of the ramp voltage.

5. The feedback circuit of claim 3, wherein the buck-boost converter is operated in a buck mode when the error voltage is smaller than the reference voltage, and operated in a boost mode when the error voltage is larger than the reference voltage.

6. The feedback circuit of claim 1, wherein the reference duty signal is a periodic pulse signal with a duty cycle substantially equal to 50%.

7. The feedback circuit of claim 1, wherein the plurality of switching signals are switched according to the reference duty signal.

8. The feedback circuit of claim 1, wherein the digital control circuit comprises:
a logic circuit, configured to perform logic operation on the control signal and the reference duty signal to generate at least one of the plurality of switching signals.

9. The feedback circuit of claim 1, wherein the buck-boost converter comprises a plurality of switches respectively controlled by the plurality of switching signals, wherein the plurality of switches comprise a first switch, a second switch, a third switch and a fourth switch;
wherein when the buck-boost converter is operated in a buck mode, the first switch is on and the second switch, the third switch and the fourth switch are off in a first phase, and the fourth switch is on and the first switch, the second switch and the third switch are off in a second phase.

10. The feedback circuit of claim 1, wherein the buck-boost converter comprises a plurality of switches respectively controlled by the plurality of switching signals, wherein the plurality of switches comprise a first switch, a second switch, a third switch and a fourth switch;
wherein when the buck-boost converter is operated in a boost mode, the second switch is on and the first switch, the third switch and the fourth switch are off in a first phase, and the first switch and the third switch are on and the second switch and the fourth switch are off in a second phase.

11. A buck-boost converter, comprising:
a power stage, configured to receive an input voltage to generate an output voltage; and
a feedback circuit, coupled to the power stage, comprising:
an error amplifier, configured to generate an error voltage according to the output voltage;
a ramp generator, configured to generate a ramp voltage;
a first comparator, coupled to the error amplifier and the ramp generator, configured to compare the error voltage with the ramp voltage to generate a control signal; and
a digital control circuit, coupled to the first comparator, configured to generate a plurality of switching signals according to the control signal and a reference duty signal.

12. The buck-boost converter of claim 11, wherein the error voltage is only compared with the ramp voltage without being compared with another ramp voltage.

13. The buck-boost converter of claim 11, wherein the digital control circuit comprises:
a second comparator, coupled to the ramp generator, configured to compare the ramp voltage with a reference voltage to generate the reference duty signal.

14. The buck-boost converter of claim 13, wherein the reference voltage is substantially equal to one half of a peak amplitude of the ramp voltage.

15. The buck-boost converter of claim 13, wherein the buck-boost converter is operated in a buck mode when the error voltage is smaller than the reference voltage, and operated in a boost mode when the error voltage is larger than the reference voltage.

16. The buck-boost converter of claim 11, wherein the reference duty signal is a periodic pulse signal with a duty cycle substantially equal to 50%.

17. The buck-boost converter of claim 11, wherein the plurality of switching signals are switched according to the reference duty signal.

18. The buck-boost converter of claim 11, wherein the digital control circuit comprises:
a logic circuit, configured to perform logic operation on the control signal and the reference duty signal to generate at least one of the plurality of switching signals.

19. The buck-boost converter of claim 11, wherein the power stage comprises a plurality of switches respectively controlled by the plurality of switching signals, wherein the plurality of switches comprise a first switch, a second switch, a third switch and a fourth switch;
wherein when the buck-boost converter is operated in a buck mode, the first switch is on and the second switch, the third switch and the fourth switch are off in a first phase, and the fourth switch is on and the first switch, the second switch and the third switch are off in a second phase.

20. The buck-boost converter of claim 11, wherein the power stage comprises a plurality of switches respectively controlled by the plurality of switching signals, wherein the plurality of switches comprise a first switch, a second switch, a third switch and a fourth switch;
wherein when the buck-boost converter is operated in a boost mode, the second switch is on and the first switch, the third switch and the fourth switch are off in a first phase, and the first switch and the third switch are on and the second switch and the fourth switch are off in a second phase.
